(19) United States
(12) Patent Application Publication
(10) Pub. No.: US 2026/0036922 A1
(43) Pub. Date: Feb. 5, 2026

(54) TWO-COMPONENT DEVELOPER

(71) Applicant: KYOCERA Document Solutions Inc., Osaka (JP)

(72) Inventor: Masanori SUGAHARA, Osaka (JP)

(73) Assignee: KYOCERA Document Solutions Inc., Osaka (JP)

(21) Appl. No.: 19/271,483

(22) Filed: Jul. 16, 2025

(30) Foreign Application Priority Data
Aug. 5, 2024 (JP) 2024-129157

(51) Int. Cl. G03G 9/113; G03G 9/093; G03G 9/107

(52) U.S. Cl. CPC G03G 9/1136; G03G 9/09321; G03G 9/09371; G03G 9/108

(57) ABSTRACT

A two-component developer includes a positively chargeable toner and a carrier. The toner includes a toner base particle including a toner core particle and a shell layer formed of a resin containing an acrylic resin and an external additive. A surface of the carrier is coated with a resin coat layer containing a silicone resin. The external additive contains silicone-modified acrylic resin particles having a volume average particle diameter of not less than 40 nm and not more than 140 nm. When there is executed an ultrasonic treatment involving application of ultrasonic oscillation at an output power of 100 W and a frequency of 28 kHz for 1 minute in an aqueous dispersion liquid containing the toner and a nonionic surfactant, an amount of those particles among the silicone-modified acrylic resin particles which become detached from the toner base particle and liberated is not more than 0.35% by mass.

### INCORPORATION BY REFERENCE

This application is based upon and claims the benefit of priority from the corresponding Japanese Patent Application No. 2024-129157 (filed on Aug. 5, 2024), the entire contents of which are hereby incorporated by reference.

### BACKGROUND

The present disclosure relates to a two-component developer containing a positively chargeable toner for developing an electrostatic latent image.

Generally, in an electrophotographic method, a surface of an electrostatic latent image carrying member is charged by corona discharge or the like and then is exposed to light from a laser or the like so that an electrostatic latent image is formed thereon. The electrostatic latent image thus formed is developed with a toner into a toner image. The toner image thus formed is further transferred to a recording medium so as to provide a high-quality image. Customarily, in the toner used for the electrophotographic method described above, there are used toner particles (toner base particles) obtained by mixing a colorant, a charge control agent, a release agent, a magnetic material, and so on into a binder resin such as a thermoplastic resin and then subjecting a resulting mixture to kneading, pulverization, and classification.

Further, fine inorganic particles of silica, titanium oxide, or the like or fine organic particles having a large particle diameter are externally added to the toner base particles for the purposes of imparting flowability to the toner, imparting favorable charging performance to the toner, improving a property of cleaning the toner off a photosensitive drum, and suppressing embedment of an external additive into the toner due to various types of stress applied to the toner.

### SUMMARY

A two-component developer according to one aspect of the present disclosure includes a toner and a carrier capable of positively charging the toner by friction. The toner includes a toner base particle and an external additive that adheres to a surface of the toner base particle. The toner base particle includes a toner core particle containing at least a binder resin and a colorant and a shell layer with which the toner core particle is coated. The shell layer is formed of a resin containing an acrylic resin. The external additive contains silicone-modified acrylic resin particles having a volume average particle diameter of not less than 40 nm and not more than 140 nm. When there is executed an ultrasonic treatment involving application of ultrasonic oscillation at an output power of 100 W and a frequency of 28 kHz for 1 minute in an aqueous dispersion liquid containing the toner and a nonionic surfactant, an amount of those particles among the silicone-modified acrylic resin particles which become detached from the toner base particle and liberated is not more than 0.35% by mass with respect to an amount of the silicone-modified acrylic resin particles adhering thereto before execution of the ultrasonic treatment. The carrier includes a carrier core and a resin coat layer with which a surface of the carrier core is coated, and the resin coat layer contains a silicone resin.

### BRIEF DESCRIPTION OF THE DRAWINGS

FIG. 1 is a view showing one example of a sectional structure of a toner used in a two-component developer according to the present disclosure.

### DETAILED DESCRIPTION

The following describes in detail an embodiment of the present disclosure. Unless otherwise specified, evaluation results (values indicating a shape, physical properties, and so on) of a powder (more specifically, toner core particles, toner base particles, an external additive, a toner, or the like) are based on a number average of measured values obtained for a considerable number of average particles picked out from the powder. Furthermore, unless otherwise specified, a number average particle diameter of the powder is a number average value of equivalent circle diameters of primary particles thereof (diameters of circles equal in area to projections of the particles) measured using a microscope. Furthermore, unless otherwise specified, a measured value of a volume median diameter (D50) of the powder is obtained using a laser diffraction/scattering type particle size distribution measuring device (LA-750 manufactured by Horiba, Ltd.). Furthermore, unless otherwise specified, measured values of acid and hydroxyl values are obtained in accordance with “JIS (Japanese Industrial Standards) K0070-1992.” Furthermore, unless otherwise specified, measured values of a number average molecular weight (Mn) and a mass average molecular weight (Mw) are obtained using gel permeation chromatography.

Hereinafter, a term “-based” may be appended to a name of a chemical compound to form a generic name encompassing the chemical compound itself and derivatives thereof. When the term “-based” is appended to a name of a chemical compound to form a name of a polymer, the term indicates that a repeating unit of the polymer originates from the chemical compound or a derivative thereof. Furthermore, a term “(meth)acryl” may be used as a generic term for acryl and methacryl. Also, a term “(meth)acryloyl” may be used as a generic term for acryloyl (CH₂=CH—CO—) and methacryloyl (CH₂=C(CH₃)—CO—).

A two-component developer according to this embodiment is prepared by, for example, mixing a positively chargeable toner and a carrier using a mixing device (for example, a ball mill) and can be favorably used for development of an electrostatic latent image. The toner is a powder containing a plurality of toner particles (particles each having an after-mentioned configuration). In order to form a high-quality image using the two-component developer, preferably, a ferrite carrier is used as the carrier.

Furthermore, in order to form high-quality images for an extended period of time, preferably, there are used magnetic carrier particles each including a carrier core and a resin layer with which the carrier core is coated. In manufacturing the magnetic carrier particles, the carrier core may be formed of a magnetic material (for example, ferrite) or a resin in which magnetic particles are dispersed. Furthermore, magnetic particles may be dispersed in the resin layer with which the carrier core is coated. In order to form high-quality images, preferably, an amount of the toner in the two-component developer is not less than 5 parts by mass and not more than 15 parts by mass with respect to 100 parts by mass of the carrier. The positively chargeable toner is positively charged by friction with the carrier.

The toner particles contained in the toner according to this embodiment each include a core (hereinafter, referred to as a toner core particle) and a shell layer (a capsule layer) formed on a surface of the toner core particle. The shell layer is formed substantially of a resin. For example, a toner core that melts at a low temperature is coated with the shell layer having excellent heat resistance, and this makes it possible to achieve both heat-resistant storability and low-temperature fixability of the toner. An additive may be dispersed in the resin constituting the shell layer. The shell layer may entirely or partially coat the surface of the toner core particle. An external additive may adhere to a surface of the shell layer (or a surface region of the toner core particle not coated with the shell layer). Hereinafter, a toner particle formed of the toner core particle and the shell layer before adhesion of the external additive thereto is referred to as a toner base particle. Furthermore, a material for forming the toner core is referred to as a toner core material. Furthermore, a material for forming the shell layer is referred to as a shell material.

The toner according to this embodiment can be used for formation of images, for example, an electrophotographic apparatus (an image forming apparatus). The following describes one example of an image forming method performed by the electrophotographic apparatus.

First, based on image data, an electrostatic latent image is formed on a photosensitive member (for example, a surface layer portion of a photosensitive drum). Next, the electrostatic latent image thus formed is developed using a developer containing a toner. In a developing process, the toner (for example, the toner that has been charged by friction with a carrier or a blade) on a developing sleeve (for example, a surface layer portion of a developing roller in a developing device) arranged in a vicinity of the photosensitive member is caused to adhere to the electrostatic latent image so that a toner image is formed on the photosensitive member. Further, in a subsequent transfer process, the toner image on the photosensitive member is directly transferred to a recording medium (for example, paper). Alternatively, the toner image is primarily transferred to an intermediate transfer member (for example, a transfer belt), and then the toner image on the intermediate transfer member is secondarily transferred to the recording medium. After that, the toner is heated to be fixed to the recording medium. As a result, an image is formed on the recording medium. A full-color image can be formed by, for example, superimposing on each other toner images of four different colors of black, yellow, magenta, and cyan.

### [1. Basic Configuration of Toner]

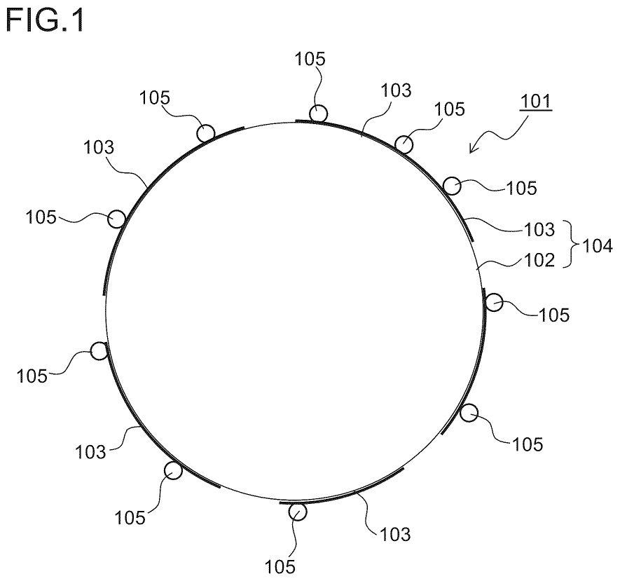

FIG. 1 is a view showing one example of a sectional structure of a toner 101 used in the two-component developer according to the present disclosure. As shown in FIG. 1, an electrostatic latent image developing toner (hereinafter, also referred to simply as a toner) 101 according to the present disclosure includes a toner core particle 102 and a shell layer 103 with which a surface of the toner core particle 102 is coated. The toner core particle 102 contains at least a binder resin, a release agent, and a colorant. The toner core particle 102 and the shell layer 103 constitute a toner base particle 104.

A thickness of the shell layer 103 is not particularly limited as long as the object of the present disclosure is not impaired and is preferably not less than 0.03 μm and not more than 1 μm, more preferably not less than 0.04 μm and not more than 0.7 μm, particularly preferably not less than 0.05 μm and not more than 0.5 μm, and most preferably not less than 0.05 μm and not more than 0.3 μm.

In a case where the thickness of the shell layer 103 is too large, it is unlikely that the shell layer 103 is destroyed under a pressure applied to the toner 101 when the toner 101 is fixed to a recording medium. In this case, softening or melting of the binder resin and the release agent contained in the toner core particle 102 does not proceed promptly, resulting in difficulty in fixing the toner 101 onto the recording medium at a temperature in a low temperature range. On the other hand, in a case where the thickness of the shell layer 103 is too small, the shell layer 103 is decreased in strength. The shell layer 103 having decreased strength may be destroyed due to an impact occurring during transportation or the like, and this makes it likely that, when stored at a high temperature, the toner 101 coagulates as a result of, for example, seepage of the release agent through a destroyed part of the shell layer 103 onto a surface of the toner 101.

The thickness of the shell layer 103 can be measured through an observation of a cross section of the toner 101 using a transmission electron microscope (TEM) and an analysis of a TEM image of the cross section of the toner 101 using commercially available image analysis software. A WinROOF (manufactured by Mitani Corporation) or the like can be used as the commercially available image analysis software.

In the toner 101 according to the present disclosure, it is not required that the toner core particle 102 be coated over an entire surface thereof with the shell layer 103. In order to achieve both heat-resistant storability and low-temperature fixability of the toner 101, preferably, the shell layer 103 coats not less than 50% and not more than 99% of an area of a surface region of the toner core particle 102. The toner core particle 102 may be coated over the entire surface thereof with the shell layer 103.

A state of the surface of the toner 101 coated with the shell layer 103 can be examined using a scanning electron microscope (SEM). Furthermore, a formation state of the shell layer 103 and an interior of the shell layer 103 of the toner 101 can be examined through an observation of the cross section of the toner 101 using the transmission electron microscope (TEM).

Resin particles 105 adhere to a surface of the toner base particle 104 (a surface of the shell layer 103). The resin particles 105 are formed of a silicone-modified acrylic resin.

In the toner 101 according to the present disclosure, the resin particles 105 are caused to adhere to the toner base particle 104, and thus a cleaning property (for example, adhesion resistance to a photosensitive drum) and developability (for example, transfer efficiency) of the toner 101 tend to be improved. Conceivably, this is because the resin particles 105 function as a spacer, making it unlikely that the toner 101 adheres to the photosensitive drum, an intermediate transfer belt, or the like.

The resin particles 105 have a volume average particle diameter of not less than 40 nm and not more than 140 nm. When the resin particles 105 have a volume average particle diameter of less than 40 nm, while it is easy for the resin particles 105 to be anchored to the surface of the toner 101, a spacer effect is reduced, and an effect of suppressing embedment of the resin particles 105 is reduced. When the resin particles 105 have a volume average particle diameter of more than 140 nm, it becomes difficult for the resin particles 105 to be anchored to the surface of the toner base particle 104, leading to contamination of the carrier or members in the image forming apparatus with the resin particles 105 being thus liberated.

Furthermore, the surface of the toner core particle 102 is coated with the shell layer 103 containing an acrylic resin as a main component (a core-shell structure is established), which is the same material as that of the resin particles 105, and thus an affinity between the resin particles 105 and the shell layer 103 is increased, so that it becomes easy for the resin particles 105 to be anchored to the surface of the toner base particle 104 by shear mixing energy generated during an external addition treatment. This results in reducing a liberated external additive present at a nip between the photosensitive drum and a cleaning blade cleaning the photosensitive drum, making it unlikely that slipping-through of the external additive occurs, and thus a drum cleaning property is improved.

Furthermore, when there is executed an ultrasonic treatment involving application of ultrasonic oscillation at an output power of 100 W and a frequency of 28 kHz for 1 minute in an aqueous dispersion liquid, desirably, an amount of those particles among the resin particles 105 which become detached from the toner base particle 104 and liberated (a liberated resin particle amount) is not more than 0.35% by mass with respect to an amount of the resin particles 105 adhering thereto before execution of the ultrasonic treatment. When the liberated resin particle amount is not less than 0.35% by mass, an amount of liberated resin particles collected by the cleaning blade is increased. The resin particles 105 have a particle diameter smaller than that of the toner 101 and are in a spherical shape, and thus an amount of those particles among the resin particles 105 which slip through the cleaning blade is increased, so that the cleaning property is degraded.

### [2. Materials of Toner]

Next, a description is given of essential or optional components as constituent components of the toner according to the present disclosure. The toner core particle contains, in a binder resin, at least a release agent and a colorant. As required, the toner core particle may also contain a charge control agent, a magnetic powder, and so on. Furthermore, as an external additive, resin particles are externally added to a surface of the toner according to the present disclosure.

The following sequentially describes the binder resin, the release agent, the colorant, the charge control agent, and the magnetic powder, which form the toner core particle, the shell material forming the shell layer, the external additive, and a method for producing the toner according to the present disclosure.

### (Binder Resin)

The toner core particle as a constituent component of the toner according to the present disclosure contains a binder resin. The binder resin that can be contained in the toner core particle is not particularly limited as long as it is a resin conventionally used as a binder resin for a toner. Specific examples of the binder resin include thermoplastic resins such as a styrene-based resin, an acryl-based resin, a styrene-acryl-based resin, a polyethylene-based resin, a polypropylene-based resin, a vinyl chloride-based resin, a polyester resin, a polyamide resin, a polyurethane resin, a polyvinyl alcohol-based resin, a vinyl ether-based resin, an N-vinyl-based resin, and a styrene-butadiene resin. Among these resins, the polyester resin is preferable in terms of dispensability of a colorant in the binder resin, chargeability of the toner, and fixability of the toner to a sheet. The following describes the polyester resin.

As the polyester resin, there can be used a polyester resin obtained by condensation polymerization or co-condensation polymerization of a dihydric or trihydric or higher alcohol component and a divalent or trivalent or higher carboxylic acid component. Examples of components used in synthesizing the polyester resin include alcohol components and carboxylic acid components listed below.

Specific examples of the dihydric or trihydric or higher alcohol component include diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylenated bisphenol A, and polyoxypropylenated bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methyl propanetriol, 2-methyl-1,2,4-butanetriol, trimethylolethane, trimethylolpropane, and 1,3,5-trihydroxymethylbenzene.

Specific examples of the divalent or trivalent or higher carboxylic acid component include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebacic acid, azelaic acid, malonic acid, and alkyl or alkenyl succinic acid such as n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccinic acid, or isododecenylsuccinic acid; and trivalent or higher carboxylic acids such as 1,2,4-benzenetricarboxylic acid (trimellitic acid), 1,2,5-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl)methane, 1,2,7,8-octanetetracarboxylic acid, pyromellitic acid, and Empol trimer acid. These divalent or trivalent or higher carboxylic acid components may be used as ester-forming derivatives such as acid halides, acid anhydrides, and lower alkyl esters. The term “lower alkyl” used herein refers to an alkyl group having 1 to 6 carbon atoms.

In a case where the binder resin is a polyester-based resin, a softening point of the polyester-based resin is preferably not less than 70° C. and not more than 130° C. and more preferably not less than 80° C. and not more than 120° C. In order to improve strength of the toner core and fixability of the toner, preferably, the polyester resin has a number average molecular weight (Mn) of not less than 1,000 and not more than 2,000. Preferably, the polyester resin has a molecular weight distribution (a ratio Mw/Mn of the mass average molecular weight (Mw) to the number average molecular weight (Mn)) of not less than 9 and not more than 21.

While, as the binder resin, a thermoplastic resin is preferably used in terms of its excellent fixability to a sheet, the thermoplastic resin can be used not only alone but also by adding thereto a cross-linking agent or a thermosetting resin. By adding the cross-linking agent or the thermosetting resin so as to introduce a partial cross-linked structure into the binder resin, it is possible to improve heat-resistant storability, durability, and so on of the toner without causing degradation in fixability of the toner. In a case of using the thermosetting resin, an amount of a cross-linked part (a gel amount) of the binder resin extracted using a Soxhlet extractor is preferably not more than 10% by mass and more preferably not less than 0.1% by mass and not more than 10% by mass with respect to a mass of the binder resin.

The thermosetting resin usable together with the thermoplastic resin is preferably an epoxy resins or a cyanate-based resin. Specific examples of a suitable thermosetting resin include a bisphenol A type epoxy resin, a hydrogenated bisphenol A type epoxy resin, a novolac type epoxy resin, a polyalkylene ether type epoxy resin, a cyclic aliphatic type epoxy resin, and a cyanate resin. Two or more types of these thermosetting resins can be used in combination.

Preferably, the binder resin has a glass transition point (Tg) of not less than 40° C. and not more than 70° C. When the glass transition point is too high, the low-temperature fixability of the toner tends to be degraded. When the glass transition point is too low, the heat-resistant storability of the toner tends to be degraded.

The glass transition point of the binder resin can be determined based on a point of change in specific heat of the binder resin obtained using a differential scanning calorimeter (DSC). More specifically, the glass transition point of the binder resin can be determined by measuring an endothermic curve of the binder resin using the differential scanning calorimeter (DSC-6200 manufactured by Seiko Instruments Inc.) as a measuring device. That is, 10 mg of the binder resin (a measurement sample) is placed in an aluminum pan, and an empty aluminum pan is used as a reference. The endothermic curve of the binder resin is obtained through measurement performed in a temperature range of not less than 25° C. and not more than 200° C. at a temperature raising rate of 10° C./minute under a normal temperature and a normal humidity. Based on the endothermic curve of the binder resin thus obtained, the glass transition point of the binder resin can be determined.

The mass average molecular weight (Mw) of the binder resin is not particularly limited as long as the object of the present disclosure is not impaired. Typically, the mass average molecular weight (Mw) of the binder resin is preferably not less than 20,000 and not more than 300,000 and more preferably not less than 30,000 and not more than 200,000. The mass average molecular weight of the binder resin can be determined by the gel permeation chromatography (GPC) based on a calibration curve previously prepared using a standard polystyrene resin.

### (Release Agent)

The toner core particle contains a release agent for the purpose of improving fixability and offset resistance. A type of the release agent that can be contained in the toner core particle is not particularly limited as long as the object of the present disclosure is not impaired. The release agent is preferably a wax, examples of which include a carnauba wax, a synthetic ester wax, a polyethylene wax, a polypropylene wax, a fluororesin-based wax, a Fischer-Tropsch wax, a paraffin wax, a montan wax, and a rice wax. Two or more types of these release agents can be used in combination. By adding such a release agent to the toner core particle, it is possible to more efficiently suppress the occurrence of an offset or image smearing (a smear around an image resulting from rubbing of the image).

In a case where the polyester resin is used as the binder resin, as the release agent, one or more selected from a group consisting of the carnauba wax, the synthetic ester wax, and the polyethylene wax are favorably used from the viewpoint of compatibility between the binder resin and the release agent. In a case where a polystyrene-based resin is used as the binder resin, as the release agent, the Fischer-Tropsch wax and/or the paraffin wax is favorably used also from the viewpoint of compatibility between the binder resin and the release agent.

The Fischer-Tropsch wax is a linear hydrocarbon compound reduced in numbers of iso-structural molecules and side chains and produced by utilizing a Fischer-Tropsch reaction, which is a catalytic hydrogenation reaction of carbon monoxide.

Among Fischer-Tropsch waxes, more preferable are those having a mass average molecular weight of not less than 1,000 and exhibiting a bottom temperature in endothermic peaks observed through DSC measurement in a range of not less than 100° C. and not more than 120° C. Examples of such a Fischer-Tropsch wax include Sasol Wax C1 (bottom temperature in endothermic peaks: 106.5° C.), Sasol Wax C105 (bottom temperature in endothermic peaks: 102.1° C.), and Sasol Wax SPRAY (bottom temperature in endothermic peaks: 102.1° C.), which are available from Sasol Ltd.

An amount of the release agent used is not particularly limited as long as the object of the present disclosure is not impaired. Preferably, a specific amount of the release agent used is not less than 1% by mass and not more than 10% by mass with respect to a total mass of the toner core particle. When the amount of the release agent used is excessively small, a desired effect of suppressing the occurrence of an offset or image smearing in a resulting image might not be obtained, while when the amount of the release agent used is excessively large, the heat-resistant storability of the toner might be degraded due to fusion between toner particles.

### (Colorant)

The toner core particle contains a colorant. As the colorant that can be contained in the toner core particle, known pigments or dyes can be used so as to correspond to a color of the toner. Specific examples of a suitable colorant that can be added to the toner include black pigments such as carbon black, acetylene black, lamp black, and aniline black; yellow pigments such as chrome yellow, zinc yellow, cadmium yellow, yellow iron oxide, mineral fast yellow, nickel titanium yellow, Naples yellow, naphthol yellow S, Hanza yellow G, Hansa yellow 10G, benzidine yellow G, benzidine yellow GR, quinoline yellow lake, permanent yellow NCG, tartrazine lake, monoazo yellow, and diazo yellow; orange pigments such as red chrome yellow, molybdenum orange, permanent orange GTR, pyrazolone orange, Vulcan orange, and indanthrene brilliant orange GK; red pigments such as red iron oxide, cadmium red, red lead, cadmium mercury sulfide, permanent red 4R, lithol red, pyrazolone red, watching red calcium salt, lake red D, brilliant carmine 6B, eosin lake, rhodamine lake B, alizarin lake, brilliant carmine 3B, and monoazo red; purple pigments such as manganese violet, fast violet B, and methyl violet lake; blue pigments such as Prussian blue, cobalt blue, alkali blue lake, a Victoria blue partially chlorinated product, fast sky blue, indanthrene blue BC, and phthalocyanine blue; green pigments such as chrome green, chromium oxide, pigment green B, malachite green lake, and final yellow green G; white pigments such as zinc white, titanium oxide, antimony white, and zinc sulfide; and extender pigments such as a barite powder, barium carbonate, clay, silica, white carbon, talc, and alumina white. Two or more types of these colorants can also be used in combination for the purpose of, for example, adjusting the toner to a desired hue.

An amount of the colorant used is not particularly limited as long as the object of the present disclosure is not impaired. Specifically, the amount of the colorant used is preferably not less than 1% by mass and not more than 10% by mass and more preferably not less than 2% by mass and not more than 7% by mass with respect to a total mass of the toner core particle.

The colorant can also be used as a master batch in which the colorant has been previously dispersed in a resin material such as a thermoplastic resin. When the colorant is used as such a master batch, preferably, a resin contained in the master batch is of the same type as that of the binder resin.

### (Charge Control Agent)

The toner core particle may contain a charge control agent for the purpose of improving a charge level of the toner and charge rising characteristics thereof, which is an indicator of whether or not it can be charged to a prescribed charge level in a short time, so as to provide a toner excellent in durability and stability. The toner according to the present disclosure is positively chargeable and thus uses a positively chargeable charge control agent.

A type of the charge control agent that can be contained in the toner core particle is not particularly limited as long as the object of the present disclosure is not impaired, and there can be used a charge control agent appropriately selected from among types of charge control agents conventionally used for a toner. Specific examples of the positively chargeable charge control agent include azine compounds such as pyridazine, pyrimidine, pyrazine, ortho-oxazine, meta-oxazine, para-oxazine, ortho-thiazine, meta-thiazine, para-thiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes consisting of azine compounds such as azine fast red FC, azine fast red 12BK, azine violet BO, azine brown 3G, azine light brown GR, azine dark green BH/C, azine deep black EW, and azine deep black 3RL; nigrosine compounds such as nigrosine, nigrosine salts, and nigrosine derivatives; acid dyes consisting of nigrosine compounds such as nigrosine BK, nigrosine NB, and nigrosine Z; metal salts of naphthenic acid or higher fatty acid; alkoxylated amines; alkylamides; and quaternary ammonium salts such as benzylmethylhexyldecyl ammonium, and decyltrimethylammonium chloride. Among these positively chargeable charge control agents, the nigrosine compounds are particularly preferable in that a more rapid charge rising property can be obtained. Two or more types of these positively chargeable charge control agents can be used in a combination.

A resin having a quaternary ammonium salt, a carboxylate, or a carboxyl group as a functional group can also be used as the positively chargeable charge control agent. More specific examples thereof include styrene-based resins having a quaternary ammonium salt, acryl-based resins having a quaternary ammonium salt, styrene-acryl-based resins having a quaternary ammonium salt, polyester resins having a quaternary ammonium salt, styrene-based resins having a carboxylate, acryl-based resins having a carboxylate, styrene-acryl-based resins having a carboxylate, polyester resins having a carboxylate, styrene-based resins having a carboxyl group, acryl-based resins having a carboxyl group, styrene-acryl-based resins having a carboxyl group, and polyester resins having a carboxyl group. These resins are not particularly limited in molecular weight as long as the object of the present disclosure is not impaired and may each be an oligomer or a polymer.

Among the resins usable as the positively chargeable charge control agent, the styrene-acryl-based resins having a quaternary ammonium salt as a functional group are more preferable in that a charge amount can be easily controlled to be in a desired range. Specific examples of a preferable acryl-based comonomer for copolymerization with a styrene unit in producing such a styrene-acryl-based resin having a quaternary ammonium salt as a functional group include (meth)acrylic acid alkyl esters such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Furthermore, as the quaternary ammonium salt, there is used a unit derived from dialkylaminoalkyl(meth)acrylate, dialkyl(meth)acrylamide, or dialkylaminoalkyl(meth)acrylamide through a quaternization process. Specific examples of the dialkylaminoalkyl(meth)acrylate include dimethylaminoethyl(meth)acrylate, diethylaminoethyl(meth)acrylate, dipropylaminoethyl(meth)acrylate, and dibutylaminoethyl(meth)acrylate. Specific examples of the dialkyl(meth)acrylamide include dimethyl methacrylamide. Specific examples of the dialkylaminoalkyl(meth)acrylamide include dimethylaminopropyl methacrylamide. Furthermore, a hydroxy group-containing polymerizable monomer such as hydroxyethyl(meth)acrylate, hydroxypropyl(meth)acrylate, 2-hydroxybutyl(meth)acrylate, or N-methylol(meth)acrylamide can be used as well at the time of polymerization.

An amount of the charge control agent used is not particularly limited as long as the object of the present disclosure is not impaired. Typically, the amount of the charge control agent used is preferably not less than 0.1% by mass and not more than 10% by mass with respect to the total mass of the toner core particle. When the amount of the charge control agent used is excessively small, it is difficult to stably charge the toner to a prescribed polarity, and this might cause an image density of a resulting image to fall below a desired value or result in difficulty in maintaining the image density for an extended period of time. Furthermore, in this case, the charge control agent can hardly be dispersed uniformly, and this might make it likely that fogging occurs in a resulting image or that a latent image carrying portion is contaminated with toner components. When the amount of the charge control agent used is excessively large, it becomes likely, for example, that an image defect occurs in a resulting image due to a charging failure under a high temperature and a high humidity caused by deterioration in environmental resistance or that the latent image carrying portion is contaminated with the toner components.

### (Magnetic Powder)

The toner core particle may contain a magnetic powder. As a material of the magnetic powder, for example, a ferromagnetic metal (more specifically, iron, cobalt, nickel, an alloy containing one or more types of these metals, or the like), a ferromagnetic metal oxide (more specifically, ferrite, magnetite, chromium dioxide, or the like), or a material that has been subjected to a ferromagnetization treatment (more specifically, a carbon material or the like to which ferromagnetism has been imparted through a thermal treatment) can be favorably used. In order to suppress elution of metal ions (for example, iron ions) from the magnetic powder, preferably, magnetic particles that have been subjected to a surface treatment are used as the magnetic powder. Each type of magnetic powder may be used alone, or a plurality of types of magnetic powders may be used in combination.

### (Shell Material)

The shell layer as a constituent component of the toner according to the present disclosure is formed of a vinyl-based resin. Furthermore, as the vinyl-based resin used to form the shell layer, a resin containing a charge control resin is used. Since the shell layer is formed of the resin containing the charge control resin, in a case of forming images for an extended period of time under various environments such as a high-temperature and high-humidity environment and a low-temperature and low-humidity environment, the toner can be charged to a desired charge amount, thus enabling formation of images having a desired density.

Preferably, the vinyl-based resin is a styrene-acrylic acid-based resin containing a styrene-based monomer and one or more types of acrylic acid-based monomers. The styrene-acrylic acid-based resin is highly hydrophobic and tends to be easily positively charged. Furthermore, conceivably, when the shell layer is formed of the styrene-acrylic acid-based resin, an affinity between the shell layer and fine resin particles of a silicone-modified acrylic resin that are caused to adhere, as an external additive, to the toner base particle is increased, suppressing detachment of the fine resin particles from the shell layer.

An amount of the vinyl-based resin used is not particularly limited as long as the object of the present disclosure is not impaired. Typically, the amount of the vinyl-based resin used is preferably not less than 1 part by mass and not more than 20 parts by mass and more preferably not less than 3 parts by mass and not more than 15 parts by mass with respect to 100 parts by mass of the toner core particle. When the amount of the vinyl-based resin used is excessively small, the toner core particle might not be able to be coated over an entire surface thereof with the shell layer. In a case where the toner core particle cannot be coated over the entire surface thereof with the shell layer, it is likely that the toner coagulates when stored at a high temperature and hence that the heat-resistant storability is degraded. On the other hand, when the amount of the vinyl-based resin used is excessively large, the shell layer is likely to have an increased thickness. In such a case, it is unlikely that a resulting toner has excellent fixability.

The mass average molecular weight (Mw) of the vinyl-based resin used to form the shell layer is not particularly limited as long as the object of the present disclosure is not impaired. Typically, the mass average molecular weight is preferably not less than 20,000 and not more than 1,500,000 and more preferably not less than 200,000 and not more than 400,000. The mass average molecular weight (Mw) of the vinyl-based resin can be measured by the gel permeation chromatography in accordance with a conventionally known method.

A method for polymerizing the above-described monomers is not limited as long as the object of the present disclosure is not impaired and can be arbitrarily selected from among solution polymerization, bulk polymerization, emulsion polymerization, suspension polymerization, and so on.

A surfactant can be used in a case where, as in the emulsion polymerization or the suspension polymerization, addition polymerization of monomers each having an unsaturated bond is performed using an aqueous solvent. The surfactant is not limited as long as the object of the present disclosure is not impaired and can be appropriately selected from a group consisting of an anionic surfactant, a cationic surfactant, and a nonionic surfactant. Examples of the anionic surfactant include a sulfuric acid ester salt type surfactant, a sulfonic acid salt type surfactant, a phosphoric acid ester salt type surfactant, and soap. Examples of the cationic surfactant include an amine salt type surfactant and a quaternary ammonium salt type surfactant. Examples of the nonionic surfactant include a polyethylene glycol type surfactant, an alkylphenol ethylene oxide adduct type surfactant, and a polyvalent alcohol type surfactant containing a derivative of a polyvalent alcohol such as glycerin, sorbitol, or sorbitan. Among these surfactants, at least one of the anionic surfactant and the nonionic surfactant is preferably used. Among these surfactants, each type may be singly used, or two or more types may be used in combination.

### (External Additive)

The toner according to the present disclosure is obtained by treating, with an external additive, the toner base particle including the toner core particle and the shell layer formed on the surface of the toner core particle. The external additive used in the toner according to the present disclosure includes at least resin particles. The resin particles are formed of a silicone-modified acrylic resin having a silicone moiety and an acrylic moiety.

The silicone-modified acrylic resin is a resin having a structure including an acrylic main chain backbone with silicone side chains, to which releasability and lubricity of silicone are imparted. The silicone-modified acrylic resin is obtained by copolymerization of a polydiorganosiloxane macromer having an acryl-based functional group and a radically polymerizable organic monomer.

Furthermore, the monomer described above can be copolymerized with another monomer. As such another monomer for copolymerization, there can be used, for example, styrene-based monomers such as styrene, methyl styrene, methoxy styrene, ethyl styrene, propyl styrene, butyl styrene, phenyl styrene, and chlorostyrene; and acrylic acid ester-based or methacrylic acid ester-based monomers such as methyl acrylate, ethyl acrylate, propyl acrylate, butyl acrylate, pentyl acrylate, dodecyl acrylate, stearyl acrylate, ethylhexyl acrylate, lauryl acrylate, methyl methacrylate, ethyl methacrylate, propyl methacrylate, butyl methacrylate, pentyl methacrylate, dodecyl methacrylate, stearyl methacrylate, ethylhexyl methacrylate, and lauryl methacrylate.

Furthermore, an additional external additive can also be used together with the resin particles. A type of the external additive used together with the resin particles is not particularly limited as long as the object of the present disclosure is not impaired and can be appropriately selected from among types of external additives conventionally used for a toner. Specific examples of a suitable external additive include silica and metal oxides such as alumina, titanium oxide, magnesium oxide, zinc oxide, strontium titanate, and barium titanate. Two or more types of these external additives can be used in combination.

### (Method for Producing Toner)

Next, a description is given of a method for producing the toner used in the two-component developer according to the present disclosure. The method for producing the toner is not particularly limited as long as the toner core particle and the shell layer are formed to have their respective prescribed structures. Furthermore, an external addition treatment is performed in which the external additive is caused to adhere to a surface of the toner base particle, which is the toner core particle coated with the shell layer. The following sequentially describes, as a favorable method for producing the electrostatic latent image developing toner described thus far, a method for producing the toner core particle, a method for forming the shell layer, and an external addition treatment method.

### (Method for Producing Toner Core Particle)

The method for producing the toner core particle is not particularly limited as long as optional components such as a colorant, a release agent, a charge control agent, and a magnetic powder can be excellently dispersed in a binder resin. Specific examples of a favorable method for producing the toner core particle include a method in which mixing of the binder resin with the components such as the colorant, the release agent, the charge control agent, and the magnetic powder is performed using a mixer or the like, followed by melting and kneading of the binder resin and the components blended into the binder resin using a kneader such as a uniaxial or biaxial extruder, and a resulting kneaded product, upon being cooled, is subjected to pulverization and classification. While not particularly limited as long as the object of the present disclosure is not impaired, generally, an average particle diameter of the toner core particle is preferably not less than 5 μm and not more than 10 μm.

### (Method for Forming Shell Layer)

The shell layer is formed by causing fine particles of a vinyl-based resin to adhere to the surface of the toner core particle so that the surface of the toner core particle is coated with the shell layer.

A description is now given of a more specific method. First, in a mixing device, an aqueous solvent having mild acidity (for example, a pH selected from a range of not less than 3 and not more than 5) is prepared by adding hydrochloric acid to ion-exchanged water. Subsequently, a dispersion liquid (a suspension) of fine particles of a vinyl-based resin as the shell material and toner core particles are added to the aqueous solvent whose pH has been adjusted.

Subsequently, a resulting mixture liquid containing the shell material and the toner core particles, which are described above, is heated, while being stirred, to a prescribed retention temperature (for example, a temperature selected from a range of not less than 50° C. and not more than 90° C.) at a prescribed rate (for example, a rate selected from a range of not less than 0.1° C./minute and not more than 3° C./minute). Moreover, the mixture liquid is retained, while being stirred, at the above-described retention temperature for a prescribed length of time (for example, a length of time selected from a range of not less than 30 minutes and not more than 4 hours). Conceivably, while the mixture liquid is retained at a high temperature, a reaction between the toner core particles and the shell material (anchoring of shell layers) proceeds. The shell material is bonded to the toner core particles, thus forming the shell layers. In the mixture liquid, the shell layers are formed on surfaces of the toner core particles, and thus a dispersion liquid of toner base particles is obtained.

As described above, in the mixture liquid, the fine particles of the vinyl-based resin having hydrophobicity are caused to adhere to the surfaces of the toner core particles, and the mixture liquid is heated so that the fine particles of the vinyl-based resin can be melted to form films. The fine particles of the vinyl-based resin, however, may also be formed into films by being heated in a drying process or receiving a physical impact force in an external addition process.

After the shell layers are formed in the above-described manner, the dispersion liquid of toner base particles is neutralized using, for example, sodium hydroxide. Subsequently, the dispersion liquid of toner base particles is cooled to, for example, a normal temperature (approximately 25° C.). Next, the dispersion liquid of toner base particles is filtered using, for example, a Buchner funnel. Thus, the toner base particles are separated from the liquid (solid-liquid separation) to provide a wet cake of toner base particles. Then, the wet cake of toner base particles thus obtained is washed. Subsequently, the toner base particles thus washed are dried. After that, as required, the toner base particles and the external additive may be mixed using a mixer (for example, an FM mixer manufactured by Nippon Coke & Engineering Co., Ltd.) so that the external additive adheres to surfaces of the toner base particles. In a case of using a spray dryer in the drying process, a dispersion liquid of the external additive (for example, silica particles) is sprayed onto the toner base particles, and thus the drying process and the external addition process can be simultaneously performed. In this manner, a toner containing a multitude of toner particles is produced.

Details and order of the processes in the above-described method for producing the toner can be arbitrarily altered depending on a configuration, characteristics, or the like required of the toner. Furthermore, the toner may be sifted after the external addition process. Furthermore, any unnecessary process may be omitted. For example, in a case where a commercially available product can be directly used as a material, using the commercially available product allows a process of preparing the material to be omitted. Furthermore, in a case where a reaction for forming the shell layers excellently proceeds without the need to adjust a pH of the mixture liquid, a pH adjusting process may be omitted. In a case of not causing the external additive to adhere to the surfaces of the toner base particles (omitting the external addition process), the toner base particles correspond to toner particles. In order to efficiently produce the toner, preferably, a multitude of toner particles are simultaneously formed. Conceivably, toner particles thus simultaneously produced mutually have substantially the same configuration.

### (External Addition Treatment Method)

The method for treating the toner base particles with the external additive is not particularly limited, and the toner base particles can be treated in accordance with a conventionally known method. Specifically, treatment conditions are adjusted to prevent particles of the external additive from being embedded into the toner base particles, and under such treatment conditions, the toner base particles are treated with the external additive using a mixer such as a Henschel mixer or a Nauta mixer.

The toner according to the present disclosure described thus far is excellent in fixability and heat-resistant storability, and in a case of forming images for an extended period of time under various environments such as a high-temperature and high-humidity environment and a low-temperature and low-humidity environment, the toner can be charged to a desired charge amount, thus enabling formation of images having a desired density. Accordingly, the electrostatic latent image developing toner according to the present disclosure is favorably usable in various types of image forming apparatuses.

### [3. Materials of Magnetic Carrier]

Next, a description is given of essential or optional components as constituent components of the magnetic carrier used in the two-component developer according to the present disclosure. The magnetic carrier according to the present disclosure includes at least a carrier core and a resin coat layer (a coating layer) with which the carrier core is coated. Furthermore, as required, a conductive agent may be contained in the resin coat layer. The following sequentially describes the carrier core forming the magnetic carrier particles, a resin material forming the resin coat layer, the conductive agent, and a method for producing the magnetic carrier according to the present disclosure.

### (Carrier Core)

The carrier core is not particularly limited, and known carrier cores for a two component-system carrier for electrophotography are adoptable, examples of which include ferrite, magnetite, and metals such as iron, nickel, and cobalt, alloys or mixtures between the above-mentioned metals and the like and a metal such as copper, zinc, antimony, aluminum, lead, tin, bismuth, beryllium, manganese, magnesium, selenium, tungsten, zirconium, or vanadium, mixtures between the above-mentioned ferrite and the like and a metal oxide such as iron oxide, titanium oxide, or magnesium oxide, a nitride such as chromium nitride or vanadium nitride, or a carbide such as silicon carbide or tungsten carbide, and ferromagnetic ferrite. Among these, particularly preferable are the ferrite and the magnetite.

Preferably, the carrier core has a volume average particle diameter of 20 μm to 70 μm. This can provide excellent developability. The volume average particle diameter can be measured using a laser diffraction/scattering type particle diameter measuring device. Examples of the laser diffraction/scattering type particle diameter measuring device include LA-700 (manufactured by Horiba, Ltd.).

### (Resin Material)

As the resin material constituting the resin coat layer, a resin containing a silicone resin could be used. Particularly preferable is a silicone resin that is excellent in toner filming property and durability and has low water vapor permeability. Examples of the silicone resin include “KR-255” manufactured by Shin-Etsu Chemical Co., Ltd. Furthermore, the carrier core can also be coated (subjected to coating) with a coating agent containing a silicone-based organic treatment agent for controlling chargeability such as a silane coupling agent. Also in such a case, a resin coat layer containing a silicone resin can be formed on a surface of the carrier core.

### (Conductive Agent)

Preferably, the resin coat layer further contains the conductive agent. When the resin coat layer further contains the conductive agent, it is possible to adjust electric resistance of the carrier particles and an ability thereof to impart charge to the toner.

Examples of the conductive agent include carbon black (particularly, conductive carbon black), metal oxide particles (for example, titanium oxide particles, strontium titanate particles, or tin oxide particles), and organic conductive agents. The conductive agent is preferably the carbon black, the titanium oxide particles, or the strontium titanate particles.

In a case where the resin coat layer contains the carbon black, the carbon black is contained in an amount of preferably not less than 1.0 parts by mass and not more than 10.0 parts by mass and more preferably not less than 2.0 parts by mass and not more than 6.0 parts by mass with respect to 100 parts by mass of a coating resin.

### (Additive)

The resin coat layer may contain, as an additive, at least one of a charge control agent, an adhesion improving agent, and a cross-linking agent. The additive is preferably a silane coupling agent (or a component derived from the silane coupling agent) and more preferably an aminosilane coupling agent (or a component derived from the aminosilane coupling agent). The aminosilane coupling agent (or a component derived from the aminosilane coupling agent) has functions as the charge control agent, the adhesion improving agent, and the cross-linking agent.

In a case where the resin coat layer contains the additive, the additive is contained in an amount of preferably not less than 4.0 parts by mass and not more than 20.0 parts by mass and more preferably not less than 8.0 parts by mass and not more than 15.0 parts by mass with respect to 100 parts by mass of the resin.

### (Method for Producing Magnetic Carrier)

A description is given of one example of the method for producing the carrier according to the present disclosure. The method for producing the carrier includes an application process of applying a resin coat layer forming solution to the carrier core and a heating process of heating the carrier core that has been subjected to the application process. The resin coat layer forming solution contains the silicone resin, a solvent, and other components (for example, the conductive agent and the additive) added as required.

Examples of the solvent used in the resin coat layer forming solution include lactam compounds (for example, 2-pyrrolidone and N-methyl-2-pyrrolidone), ketone compounds (for example, methyl ethyl ketone and methyl isobutyl ketone), cyclic ether compounds (for example, tetrahydrofuran and tetrahydropyran), alcohol compounds (for example, normal butanol and isobutanol), ester solvents (for example, ethyl acetate and isobutyl acetate), and aromatic hydrocarbon compounds (for example, toluene and xylene). The solvent used in the resin coat layer forming solution is preferably the N-methyl-2-pyrrolidone.

The resin coat layer forming solution preferably has a solid content concentration of not less than 3% by mass and not more than 20% by mass.

### (Application Process)

Examples of a method for applying the resin coat layer forming solution to the carrier core include a method in which the carrier core is immersed in the resin coat layer forming solution and a method in which the resin coat layer forming solution is sprayed on the carrier core in a fluidized bed. In the method in which the carrier core is immersed in the resin coat layer forming solution, the resin coat layer forming solution tends to be applied non-uniformly, i.e., in a smaller amount to convexities of the surface of the carrier core and in a larger amount to concavities of the surface of the carrier core. In contrast, in the method in which the resin coat layer forming solution is sprayed on the carrier core in the fluidized bed, the resin coat layer forming solution tends to be able to be applied uniformly to both of the convexities and concavities of the surface of the carrier core. For the above-described reason, the method for applying the resin coat layer forming solution to the carrier core is preferably the method in which the resin coat layer forming solution is sprayed on the carrier core in the fluidized bed.

### (Heating Process)

In this process, the carrier core that has been subjected to the application process is heated so that the solvent contained in the resin coat layer forming solution is removed. Furthermore, in a case where the resin coat layer forming solution contains an uncured polyimide silicone resin, the uncured polyimide silicone resin is thermally cured. As a result, the resin coat layer is formed from the resin coat layer forming solution. Heating conditions can be, for example, a heating temperature of not less than 200° C. and not more than 300° C. and a heating time of not less than 30 minutes and not more than 90 minutes.

The following more specifically describes effects of the present disclosure by way of examples. The present disclosure, however, is by no means limited to the examples.

### EXAMPLES

### Production Example 1

### (Production of Toner Base Particle A)

A mixture was obtained by mixing, using a Henschel mixer (Model FM-10 manufactured by Mitsui Mining Corporation), 82% by mass of a polyester resin (HP-313 manufactured by The Nippon Synthetic Chemical Industry Co., Ltd.) as a binder resin, 6.0% by mass of a colorant (carbon black MA-100 manufactured by Mitsubishi Chemical Corporation), 2.0% by mass of a charge control agent (N-01 manufactured by Orient Chemical Industries Co., Ltd.), 4.0% by mass of a charge control agent (FCA-201-PS manufactured by Fujikura Kasei Co., Ltd.), and 6.0% by mass of a release agent (WEP-4 manufactured by NOF Corporation). Next, using a biaxial extruder (TEM-26SS manufactured by Toshiba Machine Co., Ltd.), the mixture was melted and kneaded to provide a kneaded product. Using a Rotoplex pulverizer (manufactured by Toa Kikai Seisakusho), the kneaded product was coarsely pulverized to about 2 mm, and then using a mechanical pulverizer (Turbo Mill manufactured by Turbo Kogyo Co., Ltd.), a resulting coarsely pulverized product was finely pulverized to provide a finely pulverized product. The finely pulverized product was classified using an air classifier (Model EJ-L-3 (LABO) manufactured by Nittetsu Mining Co., Ltd.), and thus toner core particles (toner base particles A) having a volume average particle diameter (D50) of 7.0 μm were obtained. The volume average particle diameter was measured using a Coulter Counter Multisizer 3 (manufactured by Beckman Coulter, Inc.).

### Production Example 2

### (Production of Toner Base Particle B)

### (2-1. Production of Shell Material)

A 1-liter three-necked flask equipped with a stirring device, a thermometer, a condenser tube, and a nitrogen-introducing tube was placed in a water bath at 35° C. and used as a reaction vessel. Into the flask, 900 mL of ion-exchanged water and 80 mL of an anion surfactant (Latemul WX manufactured by Kao Corporation, component: sodium polyoxyethylene alkyl ether sulfate, solid content concentration: 26% by mass) were charged. After that, an internal temperature of the flask was raised to 80° C. using the water bath and then was retained thereat (at 80° C.). Subsequently, first and second liquids were added dropwise to contents in the flask at 80° C. over 6 hours. The first liquid was a mixture liquid of 13 g of styrene, 7 g of n-butyl acrylate (BA), 0.5 g of 2-(methacryloyloxy)ethyl trimethylammonium chloride (METAC), and 0.5 g of 2-hydroxyethyl acrylate (HPA). The second liquid was a solution of 30 mL of ion-exchanged water in which 0.5 g of potassium persulfate was dissolved. After that, the internal temperature of the flask was retained at 80° C. for 2 more hours so that the contents in the flask were polymerized. As a result, a dispersion liquid of fine resin particles having a volume average particle diameter of 32 nm was obtained.

### (2-2. Formation of Shell Layer)

A 1-liter three-necked flask equipped with a thermometer and a stirring blade was placed in a water bath, and 400 mL of ion-exchanged water was charged into the flask. After that, an internal temperature of the flask was retained at 35° C. using the water bath. Subsequently, dilute hydrochloric acid was added into the flask so as to adjust a pH of contents in the flask to 4. Next, 250 g of the shell material obtained in the above-described manner was added into the flask. Then, 300 g of the toner base particles A obtained in Production Example 1 were added into the flask. Subsequently, while the contents in the flask were stirred at a rotational speed of 100 rpm, the internal temperature of the flask was raised to 65° C. at a rate of 1° C./minute. Next, the contents in the flask were stirred for 2 hours under conditions of a temperature of 65° C. and a rotational speed of 100 rpm. Then, sodium hydroxide was added into the flask so as to adjust the pH of the contents in the flask to 7. Subsequently, the contents in the flask were cooled to a normal temperature (approximately 25° C.), and thus a dispersion liquid of pre-treatment particles (toner base particles before being subjected to an after-mentioned mechanical treatment) was obtained.

### (2-3. Washing, Drying, and Mechanical Treatment)

The dispersion liquid of pre-treatment particles obtained in Production Example 2-2 was subjected to filtration (solid-liquid separation) using a Buchner funnel, and thus a wet cake of the pre-treatment particles was obtained. After that, the wet cake of the pre-treatment particles thus obtained was re-dispersed in ion-exchanged water. Dispersion and filtration were further repeated four times to wash the pre-treatment particles.

The pre-treatment particles thus obtained were dispersed in a 50% by mass aqueous ethanol solution. Thus, a slurry of the pre-treatment particles was obtained. Subsequently, using a continuous surface-modifying device (Coatmizer manufactured by Freund Corporation), the pre-treatment particles in the slurry were dried under conditions of a hot air temperature of 40° C. and a blower air flow rate of 2 m³/minute.

Subsequently, using a fluidization mixer (FM-20C/I manufactured by Nippon Coke & Engineering Co., Ltd.), the pre-treatment particles were subjected to the mechanical treatment (in more detail, a treatment to apply a shear force) for 10 minutes under conditions of a rotational speed of 3,500 rpm and a jacket temperature of 20° C. As a result of subjecting the pre-treatment particles to the mechanical treatment, a powder of toner base particles B having a volume average particle diameter of 7.2 μm was obtained.

### Production Example 3

### (Production of Resin Particles)

### (3-1. Production of Silicone-Modified Acrylic Resin Particles)

An atmosphere inside a flask equipped with a stirring device, a thermometer, a condenser tube, a nitrogen-introducing tube, and a dropping funnel was sufficiently substituted with a nitrogen gas, and then 100 g of pure water, 4 g of sodium dodecylbenzenesulfonate, and 1 g of polyethylene glycol nonylphenyl ether were charged in the flask, with 1 g of ammonium persulfate and 0.4 g of sodium hydrogen sulfite added thereinto, and a temperature therein was raised to 60° C. Next, 35 g of butyl acrylate, 40 g of methyl methacrylate, 20 g of butyl methacrylate, 10 g of vinylsilanetriol potassium salt, and 5 g of 3-methacryloxypropylmethyldimethoxysilane were added dropwise into the flask over 3 hours. At this time, a resulting polymerization reaction solution was polymerized, as its pH was adjusted to 7 using an aqueous ammonium solution. This aqueous solution, after its pH had been adjusted to 5, was spray-dried using a spray dryer (Model FOC-25 manufactured by Ohkawara Kakohki Co., Ltd.) at 100° C. for 3 hours, and thus silicone-modified acrylic resin particles (spacer particles C having a particle diameter of 90 nm) were manufactured.

Furthermore, a nozzle hole diameter and a spray rate for spray drying were made to vary so as to adjust a particle diameter, and thus silicone-modified acrylic resin particles different in average particle diameter (spacer particles A, B, D, and E) were manufactured. As the average particle diameter, there was used an average of diameters of 50 particles randomly extracted from an SEM image.

### (3-2. Silane Coupling Agent Treatment of Silicone-Modified Acrylic Resin Particles)

With 50 g of an aqueous ethanol solution (water/alcohol=1/9 mass ratio), 300 g of the silicone-modified acrylic resin particles obtained in Production Example 3-1 and 15 g of a silane coupling agent (isobutyltriethoxysilane manufactured by Tokyo Chemical Industry Co., Ltd.) were diluted, and a resulting solution was introduced into a mixing device (Nanopersion Piccolo manufactured by Kawata Mfg. Co., Ltd.) and subjected to mixing at 80° C. for 1 hour, followed by drying at 100° C. for 12 hours. After that, using a pulverizer (Jet Mill Model 1-2 manufactured by Nippon Pneumatic Mfg. Co., Ltd.) and a ceramic flat plate as a collision plate, a resulting dried substance was pulverized at a pulverization pressure of 0.6 MPa, and thus silicone-modified acrylic resin particles that had been subjected to a silane coupling agent treatment (spacer particles F having a particle diameter of 91 nm) were obtained.

### (3-3. Titanate Coupling Agent Treatment of Silicone-Modified Acrylic Resin Particles)

Into a mixing device (Nanopersion Piccolo manufactured by Kawata Mfg. Co., Ltd.), 300 g of the silicone-modified acrylic resin particles obtained in Production Example 3-1 and 10 g of a titanate coupling agent (Plenact TTS manufactured by Ajinomoto Fine-Techno Co., Inc.) were introduced, and they were subjected to mixing at 80° C. for 1 hour, followed by drying at 100° C. for 12 hours. After that, using a pulverizer (Jet Mill Model 1-2 manufactured by Nippon Pneumatic Mfg. Co., Ltd.) and a ceramic flat plate as a collision plate, a resulting dried substance was pulverized at a pulverization pressure of 0.7 MPa, and thus silicone-modified acrylic resin particles that had been subjected to a titanate coupling agent treatment (spacer particles G having a particle diameter of 92 nm) were obtained.

### (3-4. Production of Acrylic Resin Particles)

Into a 2-liter separable flask equipped with a stirring device, a thermometer, a condenser tube, a nitrogen-introducing device, and a dropping funnel, 820 g of ion-exchanged water was charged, with a temperature therein raised to 80° C. under a nitrogen gas flow and in a constant stirring state, and after a lapse of 30 minutes, 0.7 g of ammonium persulfate as a polymerization initiator was added thereinto. Next, 55 g of ion-exchanged water, 36 g of tetramethylolpropane triacrylate whose solubility in water (at 25° C.) was not more than 1% by mass, and 108 g of an emulsified dispersion liquid obtained by emulsifying, using a homogenizer, 20 g of a 15% by mass aqueous solution of sodium dodecylbenzenesulfonate were collectively added into the flask, and then while a temperature of a polymerization reaction system was maintained at 70° C., a polymerization reaction was performed for approximately 3 hours.

Next, 126 g of ion-exchanged water, 69 g of trimethylolpropane triacrylate whose solubility in water (at 25° C.) was not more than 1% by mass, 30 g of ethylene glycol dimethacrylate, and 240 g of an emulsified dispersion liquid obtained by emulsifying, using a homogenizer, 15 g of an 8% by mass aqueous solution of sodium dodecylbenzenesulfonate were added dropwise through the dropping funnel at a dropping rate of 1 g/minute. Upon ending of approximately 3-hour dropping, the polymerization reaction was continuously performed for another 1.5 hours, and thus cross-linked fine resin particle emulsion was manufactured. Then, using a freeze dryer, the cross-linked fine resin particle emulsion obtained in the above-described manner was freeze-dried, and thus acrylic resin particles formed of cross-linked resin particles (spacer particles H having a particle diameter of 89 nm) were obtained.

### (3-5. Production of PMMA Resin Particles)

Into a reaction vessel, 100 parts by mass of methyl methacrylate and 300 parts by mass of distilled water were charged, with a redox-type polymerization initiator formed of potassium persulfate and sodium thiosulfate as a polymerization initiator and copper sulfate as an accelerator added thereinto so as to attain concentrations of 4×10⁻³ mol/L and 2.5×10⁻⁵ mol/L, respectively, and a resulting mixture was allowed to react under a nitrogen flow at 70° C. for 2 hours. Then, the mixture, after being cooled, was subjected to ultrafiltration and drying, and thus polymethyl methacrylate (PMMA) resin particles formed of cross-linked resin particles (spacer particles I having a particle diameter of 90 nm) were obtained.

### (3-6. Production of Styrene-Acrylic Resin Particles)

Into a 2-liter separable flask equipped with a stirrer, a thermometer, a nitrogen-introducing tube, a reflux condenser, and a dropping funnel, 100 parts by mass of ion-exchanged water was charged, with 1 part by mass of lauric diethanolamide added thereinto, and a temperature therein was raised to 80° C. Then, after 0.1 parts by mass of 2,2′-azobis(2-methylpropionamidine)dihydrochloride was added thereinto, 35 parts by mass of styrene, 40 parts by mass of butyl methacrylate, and 20 parts by mass of dimethylaminoacrylate were added dropwise thereinto, and a resulting mixture was subjected to emulsion polymerization at 80° C. for 2 hours to provide an emulsion. Then, the emulsion thus obtained was purified using an ultrafiltration device and then dried by a spray drying method, and thus styrene-acrylic resin particles formed of cross-linked resin particles (spacer particles J having a particle diameter of 88 nm) were obtained.

### (3-7. Production of Silicone Resin Particles)

Into a reaction vessel, 500 g of ion-exchanged water was charged, and 0.4 g of a 48% aqueous sodium hydroxide solution was added thereinto to provide an aqueous solution. To the aqueous solution, 50 g of methyltrimethoxysilane and 47 g of tetraethoxysilane were added, and a resulting mixture was subjected to a hydrolysis reaction at a maintained temperature of 15° C. for 1 hour, followed by further addition thereto of 1.8 g of a 10% aqueous sodium dodecylbenzenesulfonate solution, and a further hydrolysis reaction was performed at the same temperature for 4 hours to provide a transparent reaction product containing a silanol compound. Then, the reaction product thus obtained was subjected to a condensation reaction at a maintained temperature of 30° C. to 80° C. for 4 hours. An aqueous suspension liquid resulting from the reaction was filtered through a membrane filter, and a resulting filtrate was fed to a centrifugal separator to separate fine white particles therefrom. The fine white particles thus separated were washed in water and subjected to hot-air drying at 150° C. for 5 hours, and thus silicone resin particles (spacer particles K having a particle diameter of 91 nm) were obtained.

### (3-8. Production of Silicone Oil-Treated Fine Acrylic Particles)

A stirring bar was placed in a 300 mL Erlenmeyer flask, with 4.0 g of polydimethylsiloxane (KF-96 manufactured by Shin-Etsu Chemical Co., Ltd.) having a viscosity of 300 cs and 100 g of toluene added thereinto, and using a magnetic stirrer, stirring was performed under room temperature for 30 minutes to provide a toluene solution of silicone oil. To the solution, 20 g of fine acrylic particles obtained in Production Example 3-4 (the spacer particles H) were gradually added over 1 hour, and thus a dispersion liquid was prepared in which the fine acrylic particles were completely wet with the toluene solution of silicone oil. After that, an ultrasonic irradiation probe of a UH-2C type ultrasonic disperser (manufactured by Ultrasonic Engineering Co., Ltd.) was dipped into the dispersion liquid in the flask, and ultrasonic dispersion was performed for 1 hour, while the flask was externally cooled with water. A visual observation of a wall surface of the flask confirmed that an extremely homogeneous dispersion liquid free of coagulations was produced.

The dispersion liquid thus obtained was moved into a 500 mL eggplant-shaped flask and treated therein in a bath at a temperature of 40° C. under a reduced pressure of 10 mmHg for 5 hours using a rotary evaporator (manufactured by Tokyo Rikakikai Co., Ltd.) so that the toluene was removed. A solid thus obtained was moved onto a stainless tray and, using a reduced pressure dryer (manufactured by Yamato Scientific Co., Ltd.), was dried until a constant weight was reached at a set temperature of 50° C. under a reduced pressure of not more than 1 mmHg, and thus silicone oil-treated acrylic resin particles (spacer particles N having a particle diameter of 90 nm) were obtained.

### (3-9. Silane Coupling Agent Treatment of Silicone Resin Particles)

With 50 g of an aqueous ethanol solution (water/alcohol=1/9 mass ratio), 340 g of the silicone resin particles obtained in Production Example 3-7 and 15 g of a silane coupling agent (isobutyltriethoxysilane manufactured by Tokyo Chemical Industry Co., Ltd.) were diluted, and a resulting solution was introduced into a mixing device (Nanopersion Piccolo manufactured by Kawata Mfg. Co., Ltd.) and subjected to mixing at 80° C. for 1 hour, followed by drying at 100° C. for 12 hours. After that, using a pulverizer (Jet Mill Model 1-2 manufactured by Nippon Pneumatic Mfg. Co., Ltd.) and a ceramic flat plate as a collision plate, a resulting dried substance was pulverized at a pulverization pressure of 0.5 MPa, and thus silicone resin particles that had been subjected to a silane coupling agent treatment (spacer particles L having a particle diameter of 92 nm) were obtained.

### (3-10. Titanate Coupling Agent Treatment of Silicone Resin Particles)

Into a mixing device (Nanopersion Piccolo manufactured by Kawata Mfg. Co., Ltd.), 340 g of the silicone resin particles obtained in Production Example 3-7 and 10 g of a titanate coupling agent (Plenact TTS manufactured by Ajinomoto Fine-Techno Co., Inc.) were introduced and subjected to mixing at 80° C. for 1 hour, followed by drying at 100° C. for 12 hours. After that, using a pulverizer (Jet Mill Model 1-2 manufactured by Nippon Pneumatic Mfg. Co., Ltd.) and a ceramic flat plate as a collision plate, a resulting dried substance was pulverized at a pulverization pressure of 0.8 MPa, and thus silicone resin particles that had been subjected to a titanate coupling agent treatment (spacer particles M having a particle diameter of 92 nm) were obtained.

### (3-11. Silane Coupling Agent Treatment of Silica Particles)

Into a 3-liter glass reaction vessel equipped with a stirrer, a dropping funnel and a thermometer, 600 g of methanol, 5 g of water, and 55 g of 28% ammonia water were added to be mixed, and a temperature of a resulting mixture solution was adjusted to 45° C. While the mixture solution at the adjusted temperature was stirred, a mixture of 1,205.0 g of tetramethoxysilane and 100.6 g of tetrabutoxysilane and 400 g of 5% ammonia water heated to 40° C. to 45° C. were simultaneously started to be added dropwise thereto and kept dropping over 4 hours. Even after their dropwise addition had ended, stirring of the mixture solution was continued for another 2 hours to cause hydrolysis, and thus a suspension liquid of hydrophilic colloidal silica particles was obtained.

Then, in a 3-liter glass reaction vessel to which an ester adapter and a condenser tube were mounted, the suspension liquid of hydrophilic colloidal silica particles thus obtained was heated to a temperature of 60° C. to 70° C. so that the methanol was removed (distilled off), after which water was added thereto and the suspension liquid was heated to a temperature of 70° C. to 90° C. so that the methanol was completely removed (distilled off), and thus an aqueous suspension liquid of hydrophilic colloidal silica particles was obtained. Then, the aqueous suspension liquid of hydrophilic colloidal silica particles thus obtained was purified using an ultrafiltration device and then dried by the spray drying method, and thus colloidal silica particles having a particle diameter of 90 nm were obtained.

With 50 g of an aqueous ethanol solution (water/alcohol=1/9 mass ratio), 600 g of the colloidal silica particles thus obtained and 15 g of a silane coupling agent (isobutyltriethoxysilane manufactured by Tokyo Chemical Industry Co., Ltd.) were diluted, and a resulting solution was introduced into a mixing device (Nanopersion Piccolo manufactured by Kawata Mfg. Co., Ltd.) and subjected to mixing at 80° C. for 1 hour, followed by drying at 100° C. for 12 hours. After that, using a pulverizer (Jet Mill Model 1-2 manufactured by Nippon Pneumatic Mfg. Co., Ltd.) and a ceramic flat plate as a collision plate, a resulting dried substance was pulverized at a pulverization pressure of 1.0 MPa, and thus silica particles that had been subjected to a silane coupling agent treatment (spacer particles O having a particle diameter of 92 nm) were obtained.

Table 1 shows types of the spacer particles A to O obtained in Production Example 3, surface treatment agents therefor, and average particle diameters thereof.

TABLE 1

| | | Surface | |
|---|---|---|---|
| Spacer | | Treatment | Particle |
| Particles | Type | Agent | Diameter[nm] |
| A | Silicone-Modified Acrylic | None | 30 |
| | Resin Particles | | |
| B | Silicone-Modified Acrylic | None | 40 |
| | Resin Particles | | |
| C | Silicone-Modified Acrylic | None | 90 |
| | Resin Particles | | |
| D | Silicone-Modified Acrylic | None | 140 |
| | Resin Particles | | |
| E | Silicone-Modified Acrylic | None | 150 |
| | Resin Particles | | |
| F | Silicone-Modified Acrylic | Isobutyltri- | 91 |
| | Resin Particles | ethoxysilane | |
| G | Silicone-Modified Acrylic | TTS | 92 |
| | Resin Particles | | |
| H | Acrylic Resin Particles | None | 89 |
| I | PMMA Resin Particles | None | 90 |
| J | Styrene-Acrylic Resin | None | 88 |
| | Particles | | |
| K | Silicone Resin Particles | None | 91 |
| L | Silicone Resin Particles | Isobutyltri- | 92 |
| | | ethoxysilane | |
| M | Silicone Resin Particles | TTS | 92 |
| N | Acrylic Resin Particles | Silicone Oil | 90 |
| O | Colloidal Silica | Isobutyltri- | 92 |
| | | ethoxysilane | |

### Production Example 4

### (Production of Silicone-Coated Carrier)

Using a homomixer, 360 g of a silicone resin solution (KR-255 manufactured by Shin-Etsu Chemical Co., Ltd., solid content concentration: 50% by mass, solid content: 180 g), 9.0 g of strontium titanate (SW-100 manufactured by Titan Kogyo, Ltd.), 5.0 g of carbon black (Ketjenblack EC-300J manufactured by Lion Specialty Chemicals Co., Ltd.), and 1,500 g of toluene were mixed to provide a coating liquid.

Using a fluidized bed coating device (SFC-5 manufactured by Freund Corporation), the coating liquid was sprayed on 5,000 g of carrier cores (F-50 manufactured by Powdertech Co., Ltd. and having a particle diameter of 50 μm) while the carrier cores were allowed to flow. In this manner, carrier particles A (having a particle diameter of 54 μm) coated with the coating liquid were obtained. Coating conditions were a feed air temperature of 75° C., a feed air flow rate of 0.3 m³/minute, and a rotor rotational speed of 400 rpm. Using an electric furnace, the carrier cores coated with the coating liquid were baked at 200° C. for 1 hour, and thus there were obtained silicone-coated carriers (the carrier particles A) each including a carrier core with a silicone coat layer formed on a surface thereof.

### Production Example 5

### (Production of Fluorine-Coated Carrier)

Using a fluidized bed coating device (SFC-5 manufactured by Freund Corporation), while hot air at 80° C. was blown thereinto, coating of 10 kg of carrier cores (F-50 manufactured by Powdertech Co., Ltd. and having a particle diameter of 50 μm) was performed in 20 liters of acetone in which 2 kg of Epikote 1004 (manufactured by Japan Epoxy Resin Co., Ltd.) and 0.5 kg of a polyvinylidene fluoride-hexafluoropropylene resin (KYNAR 2801) were dissolved, after which 100 g of diethylenetriamine and 150 g of phthalic anhydride were added thereto and mixed. Resulting carrier cores were placed in a dryer and heated at 180° C. for 1 hour, and thus there were obtained fluorine-coated carriers (carrier particles B having a particle diameter of 56 μm) each including a carrier core with a fluorine coat layer formed on a surface thereof.

### Production Example 6

### (External Addition Treatment of Toner Base Particle)

Using a Henschel mixer (Model FM-10 manufactured by Mitsui Mining Corporation), into 100 parts by mass of either of the toner base particles A and the toner base particles B obtained in Production Examples 1 and 2, respectively, 1.5 parts by mass of positively chargeable silica particles (CAB-O-SIL TG-308F manufactured by Cabot Corporation) and 1.0 parts by mass of titanium oxide (MT-500B manufactured by Tayca Corporation) were mixed at a rotational speed of 3,500 rpm for 5 minutes. After that, a prescribed part(s) by mass of each of the spacer particles A to O obtained in Production Example 3 were introduced thereinto and mixed at a rotational speed of 3,500 rpm for 5 minutes so that the spacer particles were externally added. The spacer particles were adjusted to coat surfaces of the toner base particles at a coating ratio of 25%. In the above-described manner, there were manufactured toners different in amount of spacer particles liberated from the toner base particles.

### [Measurement of Amount of Spacer Particles Adhering to Toner]

An amount of spacer particles adhering to toner particles thus obtained was measured by GC-MASS or fluorescent X-rays. After that, 5 g of the toner particles were weighed and dispersed in 500 mL of an aqueous solution of polyoxyethylene octyl phenyl ether (manufactured by Wako Pure Chemical Industries, Ltd.) (25° C., 10% by mass) as an aqueous dispersion liquid, and, using an ultrasonic generator (Ultrasonic Generator Model US-300TCVP manufactured by Nippon Seiki Co., Ltd.), there was executed an ultrasonic treatment involving application of ultrasonic oscillation at an output power of 100 W and a frequency of 28 kHz for 1 minute in a resulting aqueous dispersion liquid.

After the treatment, suspended external additives (spacer particles) were removed from toner surfaces and collected, and the toner particles were collected by filtration. The suspended spacer particles thus collected and the toners thus collected by filtration were measured by the GC-MASS or fluorescent X-rays, and based on a difference between amounts of spacer particles adhering thereto before and after the ultrasonic treatment, a proportion of spacer particles remaining adhering to surfaces of the toner particles was determined by a formula (1) below. Here, a calibration curve is previously prepared using a sample containing a known amount of spacer particles, and a toner before being subjected to the treatment and the toner collected by filtration are measured by the GC-MASS or fluorescent X-rays, so that there are determined an amount of spacer particles adhering to the toner base particles before being subjected to the treatment (Fbefore) and an amount of spacer particles remaining adhering to the toner base particles without being detached therefrom (Fafter).

$$Spacer Particle Adhesion Rate = 100 \times Fafter / Fbefore \qquad ( 1 )$$

### (Fluorescent X-Ray Measurement)

Using a pressure molding machine, 2 g of a toner is subjected to compression molding under pressurizing conditions of 6 metric tons and 1 minute. Further, using a fluorescent X-ray measuring device (ZSX Primus IV manufactured by Rigaku Holdings Corporation), a net intensity of Si in a thus compression-molded sample is measured through a total element analysis under measurement conditions of a tube voltage of 40 KV and a tube current of 70 mA.

### Production Example 7

### (Production of Two-Component Developer)

Using a ball mill, either of the carrier particles A and the carrier particles B obtained in Production Examples 4 and 5, respectively, and each of the toners obtained in Production Example 6 were mixed for 30 minutes so that contents of the toners were 8% by mass with respect to the carriers, and thus two-component developers according to Disclosure Examples 1 to 5 and Comparative Examples 1 to 13 were prepared. Table 2 shows types of toner base particles constituting the toners in the two-component developers, types of spacer particles, amounts of the spacer particles added, coating ratios thereof, detachment ratios thereof, and types of the carriers.

TABLE 2

| | Toner | | | | | |
|---|---|---|---|---|---|---|
| | | Spacer Particles | | | | |
| | | | Amount of | | | |
| | | | Spacer | | Amount of | |
| | | | Particles | | Spacer | |
| | Toner | | Added | Coating | Particles | |
| | Base | | [Parts | Ratio | Detached | |
| Developer | Particle | Type | by Mass] | [%] | [%] | Carrier |
| Disclosure | B | B | 0.8 | 30 | 0.016 | A |
| Example 1 | | | | | | |
| Disclosure | B | C | 1.7 | 29 | 0.126 | A |
| Example 2 | | | | | | |
| Disclosure | B | D | 2.7 | 29 | 0.340 | A |
| Example 3 | | | | | | |
| Disclosure | B | F | 1.7 | 28 | 0.342 | A |
| Example 4 | | | | | | |
| Disclosure | B | G | 1.7 | 28 | 0.345 | A |
| Example 5 | | | | | | |
| Comparative | B | A | 0.6 | 30 | 0.007 | A |
| Example 1 | | | | | | |
| Comparative | B | E | 2.9 | 29 | 0.392 | A |
| Example 2 | | | | | | |
| Comparative | A | C | 1.7 | 29 | 0.410 | A |
| Example 3 | | | | | | |
| Comparative | A | C | 1.7 | 29 | 0.410 | B |
| Example 4 | | | | | | |
| Comparative | B | C | 1.7 | 29 | 0.126 | B |
| Example 5 | | | | | | |
| Comparative | B | H | 1.5 | 29 | 0.08 | A |
| Example 6 | | | | | | |
| Comparative | B | I | 1.5 | 28 | 0.085 | A |
| Example 7 | | | | | | |
| Comparative | B | J | 1.5 | 29 | 0.145 | A |
| Example 8 | | | | | | |
| Comparative | B | K | 1.9 | 28 | 0.413 | A |
| Example 9 | | | | | | |
| Comparative | B | L | 1.9 | 28 | 0.420 | A |
| Example 10 | | | | | | |
| Comparative | B | M | 1.9 | 28 | 0.424 | A |
| Example 11 | | | | | | |
| Comparative | B | N | 1.5 | 28 | 0.191 | A |
| Example 12 | | | | | | |
| Comparative | B | O | 3.3 | 28 | 0.610 | A |
| Example 13 | | | | | | |

### [Evaluations of Charging Stability, Transfer Characteristics, and Drum Cleaning Property]

The two-component developers according to Disclosure Examples 1 to 5 and Comparative Examples 1 to 13 were each loaded in a developing device of an evaluation apparatus (a modified version of TASKalfa 4054ci manufactured by Kyocera Document Solutions Japan Inc.), and durable printing of 50,000 sheets was performed at a printing rate of 5% under a normal temperature and normal humidity environment (at a temperature of 23.5° C. and a humidity of 50%) for evaluations of charging stability, transfer characteristics, and a drum cleaning property, which were performed in accordance with a method described below.

### (Charging Stability)

At the start of printing and after printing of 50,000 sheets (after the durable printing), the developers on developing rollers were collected and, using a suction-type compact charge amount measuring device (manufactured by Trek, Inc.), were passed through a sieve (made of stainless steel, twilled, wire diameter: 0.0027 mm) having a mesh size of 38 μm so that only the toners were sucked, and toner charge amounts thereof were measured. Furthermore, also under a high-temperature and high-humidity environment (at a temperature of 32.5° C. and a humidity of 80%), toner charge amounts at the start of printing were measured by a similar method. Evaluation criteria used for evaluating charging stability were as follows.
Excellent (E): charge amount of not less than 25 μC/g and less than 35 μC/g (practical use level)
Good (G): charge amount of not less than 15 μC/g and less than 25 μC/g (practical use level)
Poor (P): charge amount of less than 15 μC/g or not less than 35 μC/g (out of the range of practical use)

### (Transfer Characteristics)

Similarly to measurement of the charge amounts, at the start of printing and after printing of 50,000 sheets (after the durable printing), transfer efficiency was measured. The transfer efficiency is calculated by a formula (1) below, where A denotes an amount of a toner adhering on a transfer belt and B denotes an amount of a toner adhering on a medium in a case of outputting a solid image (an evaluation image) of 0.5 cm in length and 20 cm in width. In measuring the toner adhering amount A on the transfer belt and the toner adhering amount B on the medium, the evaluation apparatus was stopped from operating at timings of immediately after development and immediately before fixing, respectively, for collection of the toners using a suction-type compact charge amount measuring device (manufactured by Trek, Inc.), and weights thereof were measured using a precision balance.

$$Transfer Efficiency ( \% ) = B / A \times 100 \qquad ( 1 )$$

Evaluation criteria used for evaluating transfer characteristics were as follows.
Excellent (E): transfer efficiency of not less than 96% (practical use level)
Good (G): transfer efficiency of 92% to 95% (practical use level)
Fair (F): transfer efficiency of 88% to 91% (out of the range of practical use)
Poor (P): transfer efficiency of not more than 87% (out of the range of practical use)

### (Drum Cleaning Property)

After the durable printing of 50,000 sheets, a half-tone image was printed. The half-tone image thus obtained was visually inspected for presence or absence of longitudinal streak-shaped image defects. Furthermore, after printing of the half-tone image, a visual inspection was performed to check whether or not a toner component had adhered to a surface of a charger. Evaluation criteria used for evaluating cleaning performance were as follows.
Good (G): No longitudinal streak-shaped image defects were observed on the half-tone image, and there was observed no adhesion of the toner component to the surface of the charger (practical use level).
Fair (F): No longitudinal streak-shaped image defects were observed on the half-tone image, and there was observed slight adhesion of the toner component to the surface of the charger (practical use level).
Poor (P): Longitudinal streak-shaped image defects were observed on the half-tone image, and there was observed considerable adhesion of the toner component to the surface of the charger (out of the range of practical use).

Table 3 shows results of evaluating the charging stability, the transfer characteristics, and the cleaning property of the two-component developers according to Disclosure Examples 1 to 5 and Comparative Examples 1 to 13. Numerical values in Table 3 are measured values of the charge amounts and the transfer efficiency.

TABLE 3

| | Charge Amount | | | Transfer Efficiency | | Drum Cleaning | |
|---|---|---|---|---|---|---|---|
| | [μC/g] | | | [%] | | Property | |
| | At Start | After | | At Start | After | At Start | After |
| | of | Durable | Under HH | of | Durable | of | Durable |
| | Printing | Printing | Environment | Printing | Printing | Printing | Printing |
| Disclosure | E/34 | E/27 | G/24 | E/96 | G/92 | G | G |
| Example 1 | | | | | | | |
| Disclosure | E/32 | E/29 | G/23 | E/97 | G/93 | G | G |
| Example 2 | | | | | | | |
| Disclosure | E/31 | E/26 | G/23 | E/98 | G/95 | G | G |
| Example 3 | | | | | | | |
| Disclosure | E/30 | E/27 | E/26 | G/95 | G/92 | G | G |
| Example 4 | | | | | | | |
| Disclosure | E/31 | E/26 | E/25 | G/94 | G/92 | G | G |
| Example 5 | | | | | | | |
| Comparative | E/33 | E/27 | G/24 | G/94 | F/90 | G | G |
| Example 1 | | | | | | | |
| Comparative | E/31 | G/23 | G/21 | E/99 | E/96 | F | P |
| Example 2 | | | | | | | |
| Comparative | G/23 | F/13 | G/16 | E/97 | G/93 | F | P |
| Example 3 | | | | | | | |
| Comparative | G/21 | F/11 | F/14 | E/97 | G/92 | F | P |
| Example 4 | | | | | | | |
| Comparative | E/31 | F/14 | G/23 | E/97 | G/93 | G | G |
| Example 5 | | | | | | | |
| Comparative | E/37 | G/22 | E/26 | F/89 | P/84 | G | G |
| Example 6 | | | | | | | |
| Comparative | E/38 | G/21 | E/27 | F/90 | P/84 | G | G |
| Example 7 | | | | | | | |
| Comparative | E/38 | G/24 | E/27 | F/88 | P/85 | G | G |
| Example 8 | | | | | | | |
| Comparative | G/20 | P/9 | F/12 | G/95 | P/81 | F | P |
| Example 9 | | | | | | | |
| Comparative | G/18 | P/8 | G/15 | G/93 | P/82 | F | P |
| Example 10 | | | | | | | |
| Comparative | G/18 | P/7 | G/15 | G/92 | P/82 | F | P |
| Example 11 | | | | | | | |
| Comparative | E/31 | E/26 | E/24 | P/87 | P/84 | G | G |
| Example 12 | | | | | | | |
| Comparative | F/12 | P/4 | P/6 | E/99 | P/81 | P | P |
| Example 13 | | | | | | | |

### Example 13

As is apparent from Table 3, the developers according to Disclosure Examples 1 to 5 in each of which an amount of spacer particles detached from the toner particles was not more than 0.35% exhibited an excellent drum cleaning property. Furthermore, since silicone-modified acrylic resin particles having a low adhesion property were used as the spacer particles, they also exhibited excellent transfer characteristics. Furthermore, since anchoring of the spacer particles to the toner particles had been achieved to provide a spacer effect and silicone-coated carriers having a low adhesion property were used as the carriers, an amount of contamination of the carriers with the external additives was reduced, and thus they also exhibited excellent charging stability.

Particularly, the developer according to Disclosure Example 4 using the spacer particles F obtained by treating surfaces of silicone-modified acrylic resin particles with a silane coupling agent and the developer according to Disclosure Example 5 using the spacer particles G obtained by treating surfaces of silicone-modified acrylic resin particles with a titanate coupling agent exhibited even higher charging stability under a high-temperature and high-humidity environment than the developers according to Disclosure Examples 1 to 3.

In contrast, the developer according to Comparative Example 1 used the spacer particles A having a particle diameter as small as 30 nm, failing to provide a sufficient spacer effect, and thus exhibited deterioration in transfer efficiency after the durable printing. On the other hand, the developer according to Comparative Example 2 used the spacer particles E having a particle diameter as large as 150 nm, having difficultly in being anchored to toner surfaces, and thus exhibited deterioration in drum cleaning property.

Furthermore, in the developer according to Comparative Example 3 using the toner base particles A each including no shell layer formed therein, surfaces of the toner base particles were formed of a polyester resin, and thus it was difficult for the spacer particles to be anchored thereto, so that the developer exhibited deterioration in drum cleaning property. In the developer according to Comparative Example 4 using the toner base particles A and the fluorine-coated carrier particles B, it was difficult for the spacer particles to be anchored for a similar reason to that of Comparative Example 3, and since contamination of fluorine-coated carriers with the external additive proceeded more than in a case of silicone-coated carriers, the developer exhibited degradation in charge amount after the durable printing. In the developer according to Comparative Example 5 using the toner base particles B each including a shell layer of an acrylic resin formed therein and the carrier particles B, while it was easier for the spacer particles to be anchored than in Comparative Example 4, liberated spacer particles were also present, causing contamination of fluorine-coated carriers therewith to proceed, and thus the developer exhibited degradation in charge amount after the durable printing.

Furthermore, in the developers according to Comparative Examples 6 to 8 using, as the spacer particles, fine acrylic particles, fine PMMA particles, and fine styrene-acrylic particles, respectively, the spacer particles had a high adhesion property, and thus the developers exhibited deterioration in transfer characteristics. In the developers according to Comparative Examples 9 to 11 using fine silicone particles as the spacer particles, the fine silicone particles caused positive chargeability of the toners to be degraded, and thus the developers exhibited deterioration in charging stability. Furthermore, since the spacer particles had a low adhesion property, it was difficult for the spacer particles to be anchored to the toner particles, and thus the developers exhibited deterioration in drum cleaning property.

In the developer according to Comparative Example 12 using silicone oil-treated acrylic resin particles as the spacer particles, silicone oil had a higher adhesion property than that of a silicone resin, and thus the developer exhibited deterioration in transfer characteristics. In the developer according to Comparative Example 13 using silica particles treated with a silane coupling agent as the spacer particles, silica had high negative chargeability, and thus the developer exhibited degradation in positive chargeability of the toner. Furthermore, the spacer particles had a low adhesion property to be low in affinity with the toner base particles, and thus the developer exhibited deterioration in drum cleaning property.

The foregoing results have confirmed that, when a toner using a toner base particle including a toner core particle and a shell layer of an acrylic resin formed on a surface of the toner core particle is used in combination with a silicone-coated carrier, a two-component developer is provided that is excellent in charging stability, transfer characteristics, and drum cleaning property at the start of printing and after durable printing. In the toner, as spacer particles, silicone-modified acrylic resin particles having a volume average particle diameter of not less than 40 nm and not more than 140 nm are externally added to a surface of the toner base particle, and the spacer particles have a detachment ratio of not more than 35%.

The present disclosure is usable in a two-component developer used in an electrophotographic method. Through the use of the present disclosure, it is possible to provide a two-component developer having stable transfer characteristics and stable positive chargeability and an excellent drum cleaning property.

What is claimed is:

1. A two-component developer, comprising:
a toner including:
a toner base particle that includes:
a toner core particle containing at least a binder resin and a colorant; and
a shell layer with which the toner core particle is coated; and
an external additive that adheres to a surface of the toner base particle; and
a carrier capable of positively charging the toner by friction,
wherein
the shell layer is formed of a resin containing an acrylic resin,
the external additive contains silicone-modified acrylic resin particles having a volume average particle diameter of not less than 40 nm and not more than 140 nm,
when there is executed an ultrasonic treatment involving application of ultrasonic oscillation at an output power of 100 W and a frequency of 28 kHz for 1 minute in an aqueous dispersion liquid containing the toner and a nonionic surfactant, an amount of those particles among the silicone-modified acrylic resin particles which become detached from the toner base particle and liberated is not more than 0.35% by mass with respect to an amount of the silicone-modified acrylic resin particles adhering thereto before execution of the ultrasonic treatment,
the carrier includes:
a carrier core; and
a resin coat layer with which a surface of the carrier core is coated, and
the resin coat layer contains a silicone resin.

2. The two-component developer according to claim 1, wherein
surfaces of the silicone-modified acrylic resin particles are treated with a silane coupling agent or a titanate coupling agent.

3. The two-component developer according to claim 1, wherein
the toner core particle contains a polyester resin as the binder resin, and
the shell layer is formed of a styrene-acrylic acid-based resin containing a styrene-based monomer and one or more types of acrylic acid-based monomers.
